(19) United States
(12) Patent Application Publication
(10) Pub. No.: US 2026/0213279 A1
(43) Pub. Date: Jul. 23, 2026

(54) ELECTRODE ASSEMBLY AND BATTERY INCLUDING THE ELECTRODE ASSEMBLY

(71) Applicant: SAMSUNG SDI CO., LTD., Yongin-si (KR)

(72) Inventors: Byoung Hwi LIM, Suwon-si (KR); Hyun Ho CHO, Suwon-si (KR); Soong Ji BOO, Suwon-si (KR); Young Chang KIM, Suwon-si (KR); Geon Kyu SUNG, Suwon-si (KR)

(21) Appl. No.: 19/439,625

(22) Filed: Jan. 5, 2026

(30) Foreign Application Priority Data
Jan. 22, 2025 (KR) 10-2025-0009189

(51) Int. Cl. H01M 10/0587; H01M 50/107

(52) U.S. Cl. CPC H01M 10/0587; H01M 50/107

(57) ABSTRACT

A cylindrical electrode assembly includes a first electrode, a first separator, a second electrode, and a second separator, with the first electrode, first separator, second electrode, and second separator being stacked and wound into a cylindrical electrode assembly. The first separator includes an extended portion that extends longer than a winding-end-side end of the first electrode. The first extended portion is bent to surround the winding-end-side end of the first electrode.

### CROSS-REFERENCE TO RELATED APPLICATION

The present application claims priority to and the benefit of Korean Patent Application No. 10-2025-0009189, filed on January 22, 2025, in the Korean Intellectual Property Office, the entire disclosure of which is incorporated herein by reference.

### BACKGROUND

### 1. Technical Field

The present disclosure relates to an electrode assembly and a battery including the electrode assembly.

### 2. Description of the Related Art

Secondary batteries can be discharged and then recharged, unlike primary batteries which cannot be recharged. Low-capacity secondary batteries are used in small portable electronic devices such as smartphones, feature phones, notebook computers, digital cameras, and camcorders. High-capacity batteries are widely used as power sources for driving a motor, powering storage batteries, and other such hardware components in hybrid vehicles, electric vehicles, and the like. A secondary battery includes electrodes, an electrode assembly, a case, electrode terminals, etc. The electrodes include a positive electrode and/or a negative electrode. The electrode assembly is accommodated in a case, with the electrode terminals connected to the electrode assembly.

As technology advances, there is a need for high-capacity batteries. In some implementations, a battery pack may include a plurality of batteries that are electrically connected. A battery may be applicable to an electronic device as a battery module that includes a plurality of batteries and/or a battery pack that includes a plurality of battery modules. In this case, the electronic device may require high output and/or high capacity and may be, for example, electric vehicles and the like.

The battery includes an electrode assembly, which functions as a unit structure that performs operations of charging and discharging power. Among the electrode assemblies, a cylindrical electrode assembly may be manufactured by winding a sheet-shaped laminate having a relatively long length compared to its width. For example, a laminate may be formed of a negative electrode and/or a separator and/or a positive electrode and/or a separator, with the laminate being formed into a roll shape. In the winding-end portion of such a cylindrical electrode assembly, the negative electrode positioned at the outermost end covers an end portion of the positive electrode, and a change corresponding to the thickness of the positive electrode is present at the end portion of the positive electrode. A technical problem that sometimes needs to be addressed is one where, as the battery is repeatedly charged and discharged, cracks occur in the negative electrode due to the change at the position facing the end portion of the positive electrode.

The information disclosed in the background section is only intended to improve understanding of the background of the present disclosure, and therefore, may include information that does not constitute related or prior art.

### SUMMARY OF THE DISCLOSURE

The present disclosure is directed to providing an electrode assembly, which can prevent cracks from occurring in an electrode in a winding-end portion of a cylindrical electrode assembly, and a battery including the electrode assembly.

However, technical problems to be solved by the present disclosure are not limited to the problems described above. And other problems that are not described may be clearly understood by those skilled in the art from the description of the disclosure described below.

According to one embodiment of the present disclosure, provided herein is an electrode assembly comprising a first electrode, a first separator, a second electrode, and a second separator, with the first electrode, the first separator, the second electrode, and the second separator being stacked and wound into a cylindrical assembly, wherein the first separator includes an extended portion that extends longer than a winding-end-side end of the first electrode, and wherein the first extended portion is bent to surround the winding-end-side end of the first electrode.

The first extended portion may be bent around a corner of the winding-end-side end of the first electrode to surround the corner. The first extended portion may have a length of 5 to 15 mm, and at least a portion of the first extended portion may be bent to surround the winding-end-side end of the first electrode. The second electrode may include a second extended portion that extends longer than the winding-end-side end of the first electrode. The separators may include one or more coating layers formed on one surface or both surfaces of a porous substrate. The first electrode may be a positive electrode and the second electrode may be a negative electrode. The electrode assembly may further include a fixing tape that covers a portion of the second electrode facing the winding-end side end of the first electrode and fixes the second electrode to the electrode assembly.

According to another embodiment, there is provided an electrode assembly, that includes a first electrode, a first separator, a second electrode, and a second separator, with the first electrode, first separator, second electrode, and second separator being stacked and wound in a cylindrical electrode assembly, wherein the second separator includes an extended portion that extends longer than a winding-end-side end of the first electrode, and wherein the third extended portion is bent to surround the winding-end-side end of the first electrode.

According to another embodiment, there is provided a battery including a cylindrical case, and a cylindrical electrode assembly accommodated inside the case, wherein the electrode assembly comprises a first electrode, a first separator, a second electrode, and a second separator, wherein the first electrode, the first separator, the second electrode, and the second separator are stacked and wound into a cylindrical electrode assembly, the first separator includes a first extended portion that extends longer than a winding-end-side end of the first electrode, and wherein the first extended portion is bent to surround the winding-end-side end of the first electrode.

### BRIEF DESCRIPTION OF THE DRAWINGS

The following drawings illustrate exemplary embodiments of the present disclosure and further describe aspects and features of the present disclosure together with the detailed description of the present disclosure. The present is not limited to the embodiments depicted in the drawings.

FIG. 1 illustrates a configuration of a battery pack;

FIG. 2 illustrates a configuration of a battery in FIG. 1;

FIG. 3 illustrates the configuration of the battery in FIG. 2;

FIG. 4 illustrates a configuration of an electrode assembly in FIG. 3;

FIG. 5 illustrates a configuration of a winding-end portion of a laminate for manufacturing a cylindrical electrode assembly according to one embodiment;

FIG. 6 illustrates a configuration of a cylindrical electrode assembly according to one embodiment;

FIG. 7 illustrates a configuration of a cylindrical electrode assembly according to another embodiment; and

FIG. 8 illustrates a configuration of a cylindrical electrode assembly according to still another embodiment.

### DETAILED DESCRIPTION OF EXEMPLARY EMBODIMENTS

Hereinafter, exemplary embodiments of the present disclosure will be described in detail with reference to the attached drawings. Prior to this, terms or words used in this specification and claims should not be interpreted limited to ordinary or dictionary meanings. Rather, the terms or words should be interpreted as meanings and concepts consistent with the technical idea of this disclosure, based on the principle that the applicant is their own lexicographer, and can properly define the concept of the term in order to describe his or her disclosure in the best way. Accordingly, it is to be understood that the embodiments described herein, and the configurations illustrated in the drawings are only some of the most exemplary embodiments of the disclosure and do not represent all of the technical ideas of the disclosure. Also, there may be various equivalents and modifications that may replace them at the time of filing. When used herein, the terms "comprise or include" and/or "comprising or including" specify the presence of the mentioned shapes, numbers, steps, operations, members, elements, and/or groups thereof and are not intended to exclude the presence or addition of one or more other shapes, numbers, operations, members, elements, and/or groups thereof. Additionally, when describing embodiments of the present disclosure, “may do”, “may be” may include “one or more embodiments of the present disclosure.”

Further, in order to help understand the disclosure, the attached drawings are not drawn to actual scale, and the dimensions of some components may be exaggerated. Furthermore, the same reference numbers may be assigned to the same components in different embodiments.

The statement that two objects for comparison are “equal” means “substantially the same.” Therefore, amounts or measures that are substantially the same may include deviations that are considered low in the art, for example, deviations of less than 5%. In addition, uniformity of a parameter over a given region may mean uniformity from an average perspective.

Although first, second, and the like are used to describe various components, the components are not limited by these terms. These terms are used only to distinguish one component from another, and unless otherwise specifically stated, it is to be understood that a first component may also be a second component.

Throughout the specification, unless otherwise specifically stated, each element may be singular or plural.

When an arbitrary component is disposed “on (or under)” a first component or “above (or below)” the first component, it can mean not only that the arbitrary component is disposed in contact with the top (or bottom) of the first component, but also that a second component can be interposed between the first component and the arbitrary component disposed on (or under) the first component.

In addition, when a component is described as being “on,” “connected to,” or “coupled to” in another component, the above components may be directly connected or coupled to each other. But it should be understood that other components may be “interposed” between each component, or each component may be “connected,” “coupled,” or “linked” through another component. In addition, when a portion is “electrically coupled” to another part, this includes not only the case where it is “directly connected,” but also includes the case where it is “connected” with another member or element interposed therebetween.

Throughout the specification, “A and/or B” means A, B, or A and B unless otherwise stated to the contrary. That is, “and/or” includes any or all combinations of a plurality of listed items. When “C to D” is stated, it means greater than or equal to C and less than or equal to D unless otherwise specifically stated.

When phrases such as “at least one of A, B, and C,” “at least one of A, B, or C,” “at least one selected from group of A, B, and C,” or “at least one selected from A, B, and C” are used to specify a list of elements A, B, and C, the phrases may refer to any and all suitable combinations.

The term “use” may be considered synonymous with the term “utilize.” As used in the present specification, the terms “substantially,” “about,” and other similar terms are used as terms of approximation rather than terms of degree, and are intended to consider an inherent variation in measured or calculated values recognized by those skilled in the art.

It will be understood that, although the terms first, second, third, etc., may be used herein to describe various elements, components, regions, layers, and/or sections. These elements, components, regions, layers, and/or sections should not be limited by these terms. These terms are used to distinguish one element, component, region, layer, or section from another element, component, region, layer, or section. Thus, a first element, component, region, layer, or section discussed below could be named a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s), as illustrated in the drawings. It will be understood that the spatially relative terms are intended to encompass different orientations of the device in use or operation in addition to the orientation depicted in the drawings. For example, when the devices shown in the drawings are inverted, an element described as “lower” or “below” becomes “upper” or “above.” Therefore, the term “below” can encompass both upward and downward directions.

The terms used in the present specification are intended to describe the embodiments of the present disclosure, and are not intended to limit the present disclosure.

Hereinafter, with reference to the attached drawings, a secondary battery and a battery pack including the secondary battery according to various embodiments of the present disclosure will be described. In this process, the thickness of lines and the sizes of components depicted in the drawings may be exaggerated for clarity and convenience. Additionally, the terms described below are defined based on their functions in the present disclosure and may vary depending on the intentions or practices of the user or operator. Therefore, the definitions of these terms should be based on the contents throughout this specification.

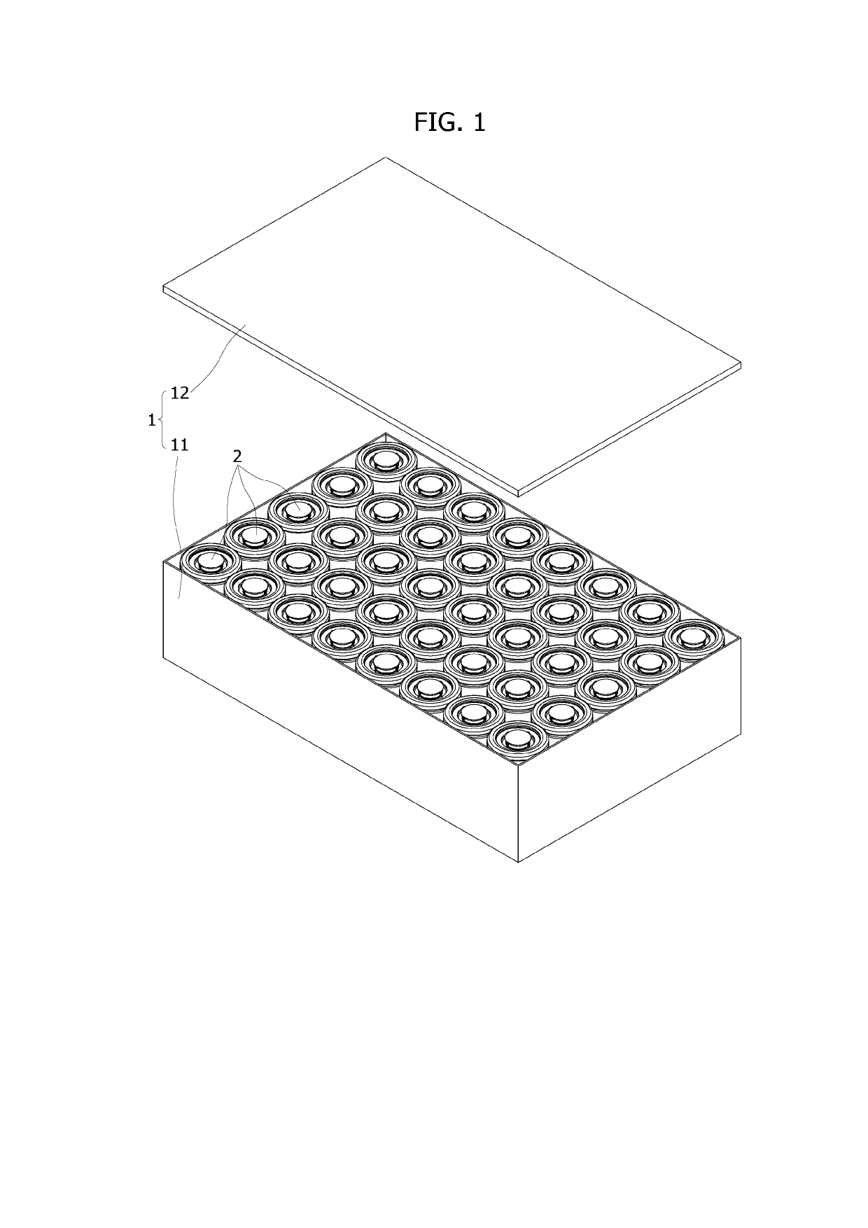

FIG. 1 illustrates an example of a configuration of a battery pack including a plurality of cylindrical batteries. Referring to FIG. 1, the battery pack includes a housing 1 and a battery 2. In some embodiments, the plurality of cylindrical batteries may represent a plurality of instances of battery 2.The housing 1 may form an approximate exterior of the battery pack and provide a space to accommodate the battery 2. The housing 1 may include a housing body 11 and a cover 12. The housing body 11 may be formed to have the shape of a box with an empty interior and one open side. A cross-sectional shape of the housing body 11 is not limited to the rectangular shape illustrated in FIG. 1, and may be designed to have various shapes such as a polygonal shape, a circular shape, an oval shape, and the like. The cover 12 may be coupled to the housing body 11, and may close the interior space of the housing body 11. As an example, the cover 12 may be formed to have a roughly plate-like shape and may be positioned to face the open side of the housing body 11. The cover 12 may be fixed to the housing body 11 by various types of coupling methods such as bolting, welding, fitting, and the like.

The battery 2 may function as a unit structure for storing and supplying power in the battery pack. A plurality of batteries 2 may be provided. The plurality of batteries 2 may be arranged in various patterns inside the housing 1, such as a grid shape or a zigzag shape, and the like. The plurality of batteries 2 may be arranged in parallel with each other. The number of batteries 2 may be designed in various ways, depending on the size, shape, and other attributes of the housing 1. A detailed configuration of the battery 2 will be described below.

The plurality of batteries 2 may be electrically connected by a bus bar (not shown). The plurality of batteries 2 may also be connected in series or parallel by the bus bar. For example, the bus bar may connect one subset of the batteries 2 arranged in the same row within the housing 1 in parallel, and connect another subset of the batteries 2 arranged in two adjacent rows in series. The bus bar may be formed of an electrically conductive material, such as copper, aluminum, or nickel.

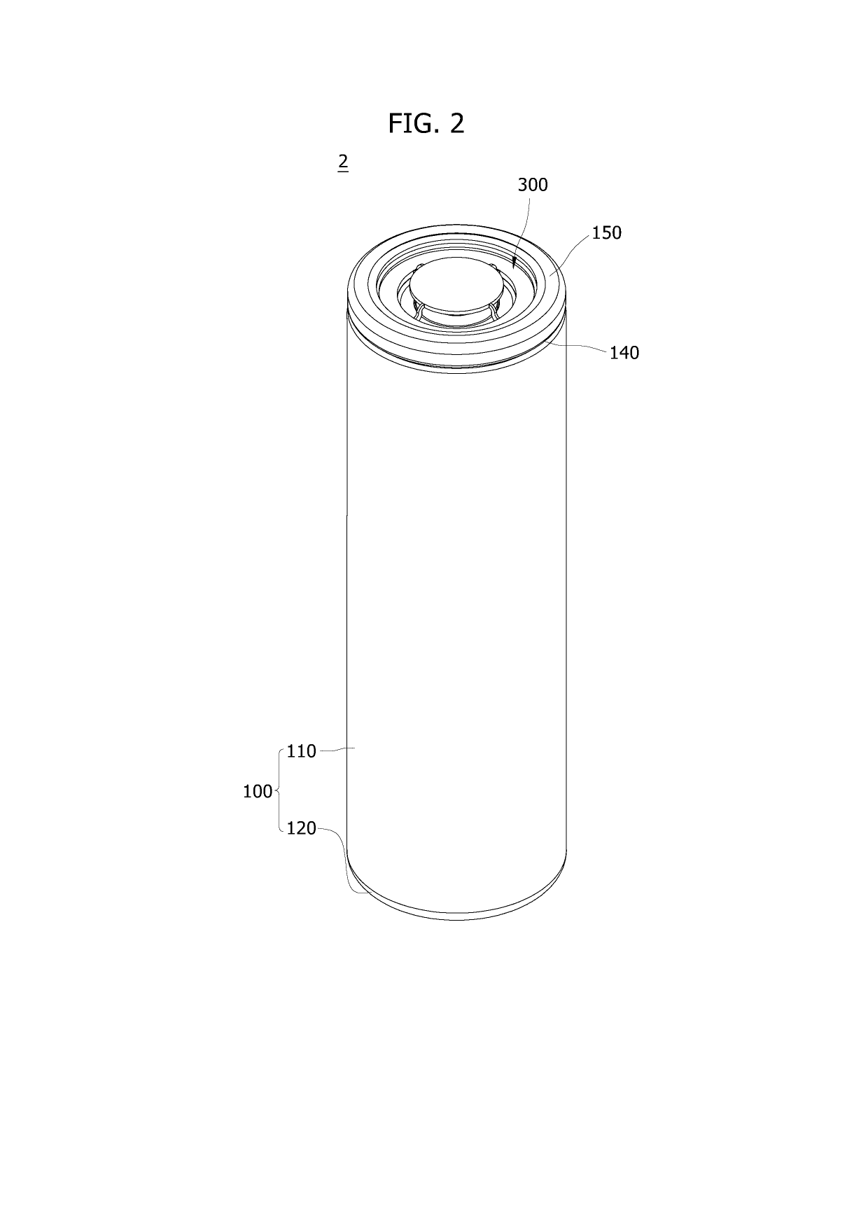

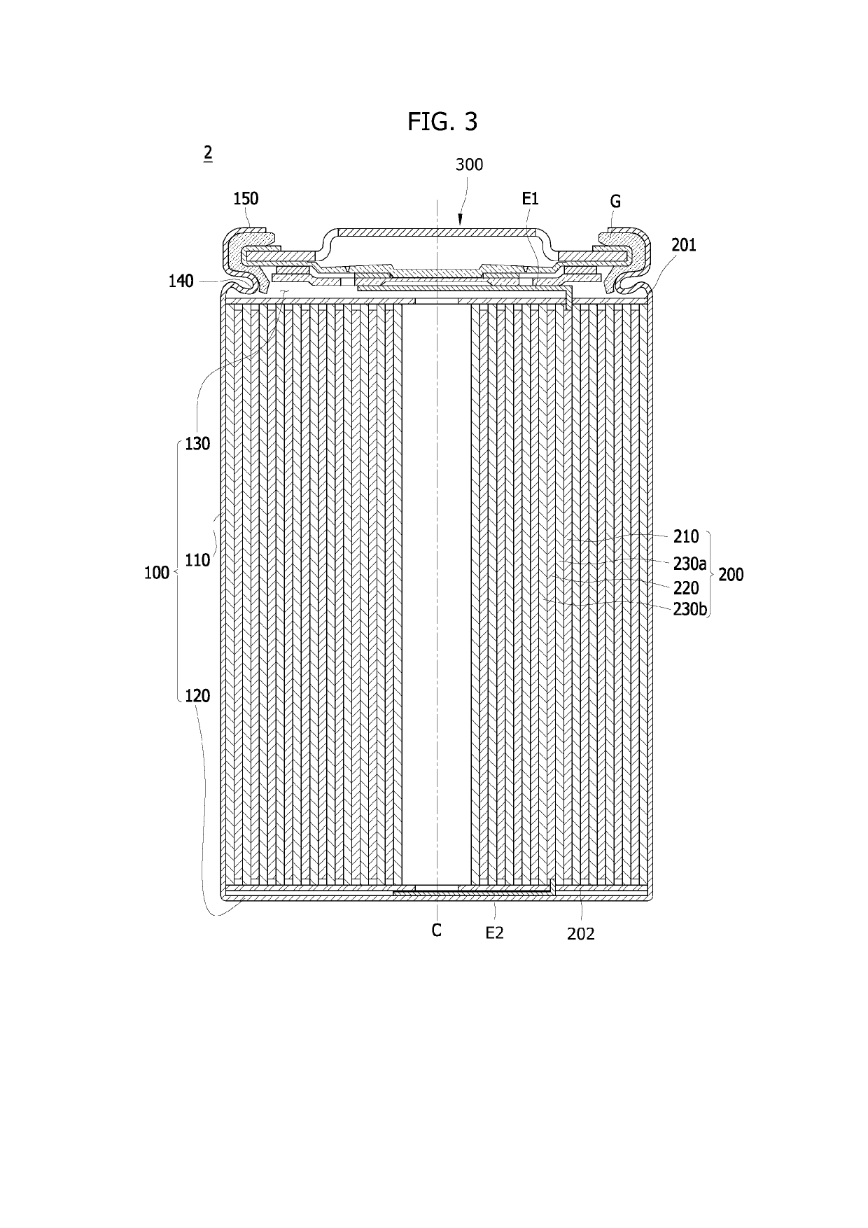

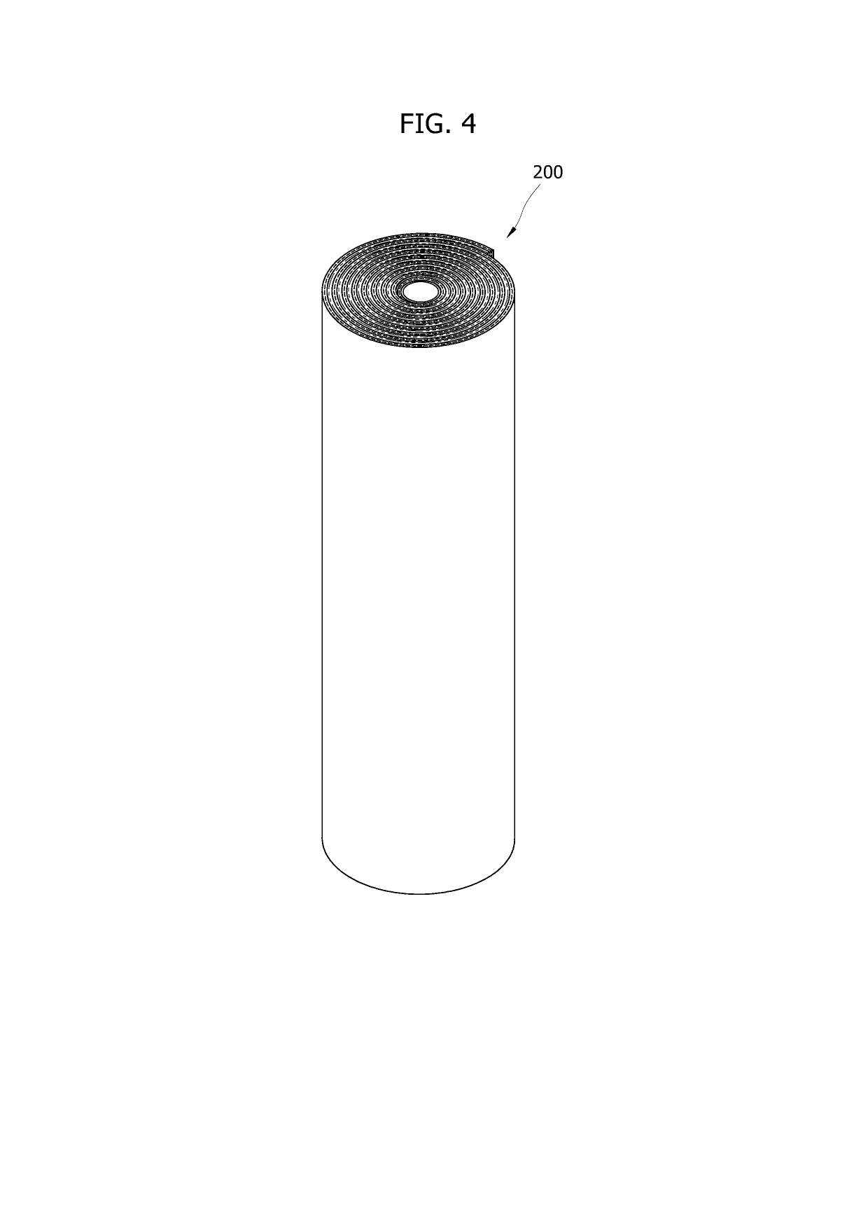

FIG. 2 illustrates a configuration of a battery according to one embodiment. FIG. 3 illustrates the configuration of the battery in FIG. 2. FIG. 4 illustrates a configuration of an electrode assembly in the battery in FIG. 3. Referring to FIGS. 2 to 4, the battery 2 may include a case 100, an electrode assembly 200, and a cap assembly 300.

The case 100 may form an approximate exterior of the battery 2. The case 100 may be formed of an electrically conductive material. In one example, the case 100 may be formed of a material including one or more forms of steel, stainless steel, aluminum, and an aluminum alloy. Accordingly, the case 100 may protect the electrode assembly 200 from external impacts and perform a heat dissipation function that dissipates heat accompanying the charging/discharging operations of the electrode assembly 200 to the outside.

The case 100 may include a side wall portion 110 having a cylindrical shape with a central axis C formed at the center. The central axis C of the case 100 may mean a central axis of the side wall portion 110. Both end portions of the side wall portion 110 may be perpendicular to the central axis C of the case 100, and both end portions of the side wall portion 110 may be formed to be open.

The case 100 may further include a bottom portion 120 that closes a lower end portion of the side wall portion 110. The bottom portion 120 may be formed to have a shape roughly similar to a circular plate, and may be disposed to face a lower end portion of the side wall portion 110. The bottom portion 120 may be perpendicular to the central axis C of the case 100. A circumferential surface of the bottom portion 120 may be coupled to the lower end portion of the side wall portion 110. The bottom portion 120 may be integrally formed with the side wall portion 110 through a drawing process or the like, or alternatively, made separately from the side wall portion 110 and then joined to the side wall portion 110 by welding or the like.

The case 100 may further include an opening 130 that opens an upper end portion of the side wall portion 110. The opening 130 may function as a configuration that provides a path for the electrode assembly 200 to be inserted into the interior of the case 100 from an upper area of the case 100, and provides a space in which the cap assembly 300may be installed. The opening 130 may refer to an empty space surrounded by an upper end portion area of the side wall portion 110 located on an opposite side of the bottom portion 120.

The electrode assembly 200 may function as a unit structure that performs charging and discharging operations of power in the battery 2. The electrode assembly 200 may include a first electrode 210, a second electrode 220, and separators 230a and 230b between the first electrode 210 and the second electrode 220. The electrode assembly 200 may be inside the case 100. The electrode assembly 200 may also be inserted into the case 100 through the opening 130 of the case 100.

The electrode assembly 200 may have a form that is wound around a winding axis in a longitudinal direction. More specifically, the electrode assembly 200 may have a form in which the first electrode 210, a first separator 230a, the second electrode 220, and a second separator 230b are stacked and wound clockwise or counterclockwise around a winding axis. Accordingly, the electrode assembly 200 may roughly have a jelly roll (cylindrical) shape. Here, the winding axis may refer to a straight line passing through the center of the electrode assembly 200. The winding axis of the electrode assembly 200 may be coaxial with the central axis C of the case 100.

The first electrode 210 may function as a positive electrode of the electrode assembly 200. The first electrode 210 may be in the form of a foil including a metal material such as aluminum or an aluminum alloy. The type, size, and shape of the first electrode 210 are not particularly limited as long as the first electrode 210 is conductive without causing an undesirable chemical change in the battery.

A first active material layer may be applied on at least a portion of the first electrode 210. The first active material layer may also be applied on both surfaces of the first electrode 210, or alternatively, may be applied on only one surface of the first electrode 210. Since the first electrode 210 functions as a positive electrode, the first active material layer may include a positive electrode active material.

As examples of the positive electrode active material, a compound capable of reversible intercalation and deintercalation of lithium (lithiated intercalation compound) may be used. Specifically, one or more of composite oxides of lithium and a metal selected from cobalt, manganese, nickel, iron, and a combination thereof may be used.

As an example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM). Here, 0<x<1, 0<y<1, 0<z<1, and x+y+z=1 may be satisfied. The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM), and may further include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM).

The first active material layer may further include a positive electrode conductive material. The positive electrode conductive material is used to impart conductivity to the first active material layer. Any material that does not cause an undesirable chemical changes and is electronically conductive may be used. Examples of the positive electrode conductive material may include carbon-based materials such as natural graphite, artificial graphite, carbon black, acetylene black, Ketjen black, carbon fibers, carbon nanofibers, or carbon nanotubes; metal-based materials in the form of metal powder or metal fibers containing copper, nickel, aluminum, and silver; conductive polymers such as polyphenylene derivatives; or mixtures thereof.

The first active material layer may further include a positive electrode binder. The positive electrode binder serves to attach particles to each other, the particles constituting the positive electrode active material. The positive electrode binder also serves to attach the positive electrode active material to the first electrode 210. Examples of the positive electrode binder include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof. The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(metha)acrylonitrile, an ethylene propylene diene copolymer, polyvinylpyridine, chlorosulfonated polyethylene, latex, polyester resin, (metha)acrylic resin, phenolic resin, epoxy resin, polyvinyl alcohol, and a combination thereof. When the aqueous binder is used as the positive electrode binder, a cellulose-based compound capable of imparting viscosity may be further included. This cellulose-based compound may be used by mixing one or more of carboxymethyl cellulose, hydroxypropyl methyl cellulose, methyl cellulose, or alkali metal salts thereof. Na, K, or Li may be used as the alkali metal. The dry binder is a polymer material capable of being fiberized and may be, for example, polytetrafluoroethylene, polyvinylidene fluoride, a polyvinylidene fluoride-hexafluoropropylene copolymer, polyethylene oxide, or a combination thereof.

The first electrode 210 may be electrically connected to the cap assembly 300. Since the first electrode 210 functions as a positive electrode of the electrode assembly 200, the cap assembly 300 may function as a positive electrode terminal of the battery 2. In one example, the first electrode 210 may be electrically connected to the cap assembly 300 by a first electrode tab E1. The first electrode tab E1 may be formed of a conductive metal material such as copper, a copper alloy, nickel, or a nickel alloy. The first electrode tab E1 is located on an upper side of the electrode assembly 200, and both end portions may be connected to the first electrode 210 and the cap assembly 300, respectively. One end portion of the first electrode tab E1 may be directly connected to the first electrode 210, or may be indirectly connected to the first electrode 210 through a separate collector plate (not shown) connected to the first electrode 210. However, the first electrode 210 is not limited to this, and may also be directly connected to the cap assembly 300 without the first electrode tab E1.

The second electrode 220 may function as a negative electrode of the electrode assembly 200. The second electrode 220 may be in the form of a foil including a metal material such as copper, a copper alloy, nickel, or a nickel alloy. The second electrode 220 may be disposed to face the first electrode 210 at a predetermined distance. The type, size, and shape of the second electrode 220 are not particularly limited as long as the second electrode 220 is conductive and does not cause undesirable chemical changes in the battery.

A second active material layer may be applied on at least a portion of the second electrode 220. The second active material layer may also be applied on both surfaces of the second electrode 220, or alternatively, may be applied on only one surface of the second electrode 220. Since the second electrode 220 functions as a negative electrode, the second active material layer may include a negative electrode active material.

The negative electrode active material may include a material capable of reversibly intercalating and deintercalating lithium ions, lithium metal, an alloy of lithium and a metal, a material capable of doping and dedoping lithium, or a transition metal oxide. The material capable of reversibly intercalating/deintercalating lithium ions may be a carbon-based negative electrode active material, such as, for example, crystalline carbon, amorphous carbon, or a combination thereof. Examples of the crystalline carbon may include graphite such as amorphous, plate-shaped, flaky, spherical, or fibrous natural graphite or artificial graphite. Examples of the amorphous carbon may include soft carbon or hard carbon, mesophase pitch carbide, calcined coke, or the like.

An alloy of lithium and a metal selected from Na, K, Rb, Cs, Fr, Be, Mg, Ca, Sr, Si, Sb, Pb, In, Zn, Ba, Ra, Ge, Al and Sn may be used as the alloy of lithium and a metal.

A Si-based negative electrode active material or Sn-based negative electrode active material may be used as the material capable of doping and dedoping the lithium. The Si-based negative electrode active material may include silicon, a silicon-carbon composite, SiOₓ(x = 1 or 2), an Si-Q alloy, or a combination thereof. In the formula Si-Q, Q is selected from an alkali metal, an alkaline earth metal, a Group 13 element, a Group 14 element (excluding Si), a Group 15 element, a Group 16 element, a transition metal, a rare earth element, and a combination thereof. The Sn-based negative electrode active material may be Sn, SnO₂, a Sn-based alloy, or a combination thereof.

The silicon-carbon composite may be a composite of silicon and amorphous carbon. According to one example, the silicon-carbon composite may be in the form of silicon particles whose surfaces are coated with amorphous carbon. For example, the silicon-carbon composite may include a secondary particle (a core) in which silicon primary particles are assembled and an amorphous carbon coating layer (a shell) located on the surface of the secondary particle. The amorphous carbon may also be located between the silicon primary particles. In one example, the silicon primary particles may be coated with the amorphous carbon. Additionally, the secondary particle may be dispersed in an amorphous carbon matrix.

The silicon-carbon composite may further include crystalline carbon. For example, the silicon-carbon composite may include a core including crystalline carbon and silicon particles and an amorphous carbon coating layer located on a surface of the core.

The Si-based negative electrode active material or the Sn-based negative electrode active material may be used in combination with the carbon-based negative electrode active material.

The second active material layer may further include a negative electrode conductive material and a negative electrode binder.

The negative electrode conductive material is used to impart conductivity to the second active material layer, and any electronically conductive material that does not cause undesirable chemical changes may be used. Examples of the negative electrode conductive material include carbon-based materials such as natural graphite, artificial graphite, carbon black, acetylene black, Ketjen black, carbon fibers, carbon nanofibers, and carbon nanotubes; metal-based materials in the form of metal powder or metal fibers containing copper, nickel, aluminum, silver, etc.; conductive polymers such as polyphenylene derivatives; or mixtures thereof.

The negative electrode binder serves to attach particles constituting the negative electrode active material to each other, and also serves to attach the negative electrode active material to the second electrode 220. Examples of the negative electrode binder include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(metha)acrylonitrile, an ethylene propylene diene copolymer, polyvinylpyridine, chlorosulfonated polyethylene, latex, polyester resin, (metha)acrylic resin, phenolic resin, epoxy resin, polyvinyl alcohol, and a combination thereof.

When the aqueous binder is used as the negative electrode binder, a cellulose-based compound capable of imparting viscosity may be further included. This cellulose-based compound may be used by mixing one or more of carboxymethyl cellulose, hydroxypropyl methyl cellulose, methyl cellulose, or alkali metal salts thereof. Na, K, or Li may be used as the alkali metal.

The dry binder is a polymer material capable of being fiberized and may be, for example, polytetrafluoroethylene, polyvinylidene fluoride, a polyvinylidene fluoride-hexafluoropropylene copolymer, polyethylene oxide, or a combination thereof.

The second electrode 220 may be electrically connected to the case 100. In one example, the second electrode 220 may be electrically connected to the case 100 by a second electrode tab E2. Since the second electrode 220 functions as a negative electrode of the electrode assembly 200, the case 100 may function as a negative electrode terminal of the battery 2. The second electrode tab E2 may be formed of a conductive metal material, such as copper, a copper alloy, nickel, or a nickel alloy.

The second electrode tab E2 is located on a lower side of the electrode assembly 200. Both end portions may be connected to the second electrode 220 and the bottom portion 120 of the case 100, respectively. One end portion of the second electrode tab E2 may be directly connected to the substrate of the second electrode 220, or may be indirectly connected to the second electrode 220 through a separate collector plate (not shown) that is already connected to the second electrode 220. However, present disclosure is not limited to this, and one end portion of the second electrode tab E2 may also be directly connected to the end of the second electrode 220.

The separators 230a and 230b may be between the first electrode 210 and the second electrode 220. The separators 230a and 230b may prevent a short circuit between the first electrode 210 and the second electrode 220, while allowing the movement of lithium ions between the first electrode 210 and the second electrode 220.

As the separators 230a and 230b, polyethylene, polypropylene, polyvinylidene fluoride or multilayer films of two or more layers thereof may be used, and mixed multilayer films such as a polyethylene/polypropylene two-layer separator, a polyethylene/polypropylene/polyethylene three-layer separator, a polypropylene/polyethylene/polypropylene three-layer separator, and the like may be used.

The separators 230a and 230b may include a porous substrate and may further include a coating layer containing an organic material, an inorganic material, or a combination thereof, positioned on one or both surfaces of the porous substrate. The porous substrate may be a polymer film formed of any one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fiber, Teflon, and polytetrafluoroethylene, or a copolymer or mixture of two or more thereof. The organic material may include a polyvinylidene fluoride-based polymer or a (meth) acryl-based polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. The organic material and the inorganic material may be present as a mixture in a single coating layer or may be present in a form of coating layers, where a coating layer including an organic material and a coating layer including an inorganic material are stacked.

A pair of separators 230a and 230b may be provided. The pair of separators 230a and 230b may face both surfaces of the first electrode 210 or the second electrode 220. The pair of separators 230a and 230b may be wound around the winding axis together with the first electrode 210 and the second electrode 220.

A first insulating plate 201 and a second insulating plate 202 may be on both sides (upper and lower sides in FIG. 3) of the electrode assembly 200, respectively. The first insulating plate 201 and the second insulating plate 202 may include an insulating material such as rubber, polyethylene (PE), polypropylene (PP), polyethylene terephthalate (PET), or the like.

The first insulating plate 201 may be formed to have a roughly circular shape. The first insulating plate 201 may be between an upper surface of the electrode assembly 200 and the cap assembly 300. Accordingly, the first insulating plate 201 may prevent the upper surface of the electrode assembly 200 from directly contacting the cap assembly 300. The first insulating plate 201 may also insulate the electrode assembly 200 and the cap assembly 300 from each other. In addition, the first insulating plate 201 may have a through hole (not shown) formed therein through which the first electrode tab E1 may pass.

The second insulating plate 202 may be formed to have a roughly circular shape. The second insulating plate 202 may be between a lower surface of the electrode assembly 200 and the bottom portion 120 of the case 100. Accordingly, the second insulating plate 202 may prevent the lower surface of the electrode assembly 200 from directly contacting the bottom portion 120 of the case 100, and may insulate the electrode assembly 200 and the bottom portion 120 of the case 100 from each other. The second insulating plate 202 may have a through hole (not shown) formed therein, through which the second electrode tab E2 may pass.

The cap assembly 300 may be located in the upper end portion of the side wall portion 110, i.e., the opening 130. The opening 130 of the case 100 is sealed by the cap assembly 300. To this end, the cap assembly 300 may be coupled to the case 100.

The side wall portion 110 may have a beading portion 140 formed concavely toward the central axis C of the case 100. The beading portion 140 is positioned on the lower side of the cap assembly 300 and may restrict the cap assembly 300 from being inserted into the case 100 beyond a set distance. On an upper side of the beading portion 140, a crimping portion 150 may be formed, in which the upper end portion of the side wall portion 110 is bent toward the central axis C of the case 100. The crimping portion 150 may be located on an upper side of the cap assembly 300 and may prevent the cap assembly 300 from being separated from the outside of the case 100.

A gasket G may be between the case 100 and the cap assembly 300. The gasket G may function as a configuration that uses elastic restoring force to fix the cap assembly 300 to the opening 130. The gasket G may also electrically insulates the case 100 and the cap assembly 300 from each other, and prevent moisture or electrolyte from flowing in or out between the case 100 and the cap assembly 300.

The gasket G may further include an insulating material such as rubber, polyethylene (PE), polypropylene (PP), polyethylene terephthalate (PET), etc. Structurally, the gasket G may be formed to have a roughly ring shape and located on the inner side of the beading portion 140 and/or the crimping portion 150. An outer surface of the gasket G may be in close contact with an inner surface of the beading portion 140 and/or the crimping portion 150. Additionally, an inner surface of the gasket G may be in close contact with an outer surface of the cap assembly 300.

As described above, the cap assembly 300 may be electrically connected to the first electrode 210 through the first electrode tab E1. Since the first electrode 210 functions as a positive electrode of the electrode assembly 200, the cap assembly 300 may function as a positive electrode terminal of the battery. The cap assembly 300 is formed in a structure capable of blocking the flow of current, when the pressure inside the case 100 increases due to overcurrent, etc., thereby blocking the electrical connection between the battery 2 and an external device. The cap assembly 300 may also be formed in a structure that may rupture when the pressure inside the case 100 rises above a set level, thereby connecting the space inside and outside the case 100. Accordingly, the cap assembly 300 may reduce the risk of the battery 2 exploding when an overcurrent occurs.

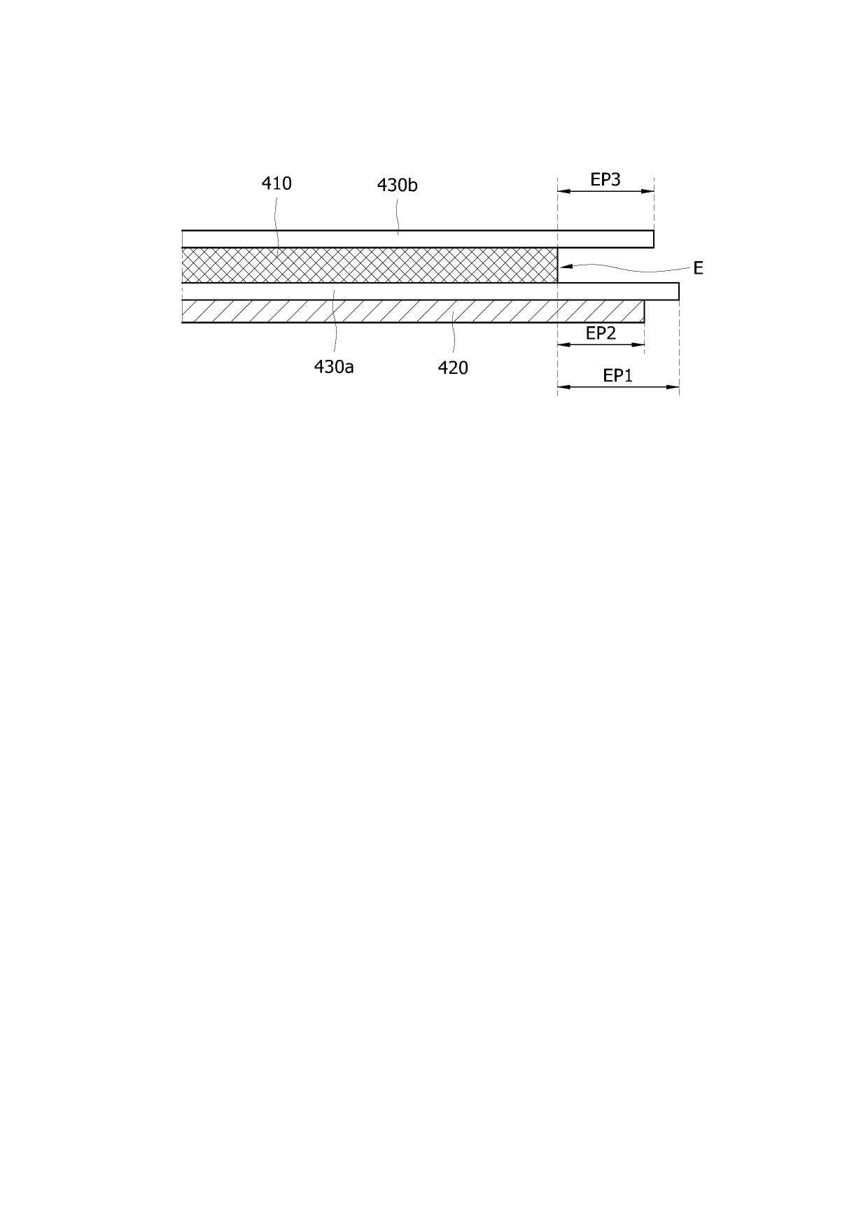

FIG. 5 illustrates a configuration of a winding-end portion of a laminate for manufacturing a cylindrical electrode assembly according to one embodiment.

Referring to FIG. 5, the laminate has a structure in which a second electrode 420, a first separator 430a, a first electrode 410, and a second separator 430b are sequentially stacked. Also, in the winding-end portion, among the components of the laminate, the first electrode 410 has the shortest length, and the other components, namely the second electrode 420, the first separator 430a, and the second separator 430b, each extend outward from the first electrode 410. More specifically, the second electrode 420 extends further than a winding-end-side end E of the first electrode 410 by a second extended portion EP2, the first separator 430a extends further than the winding-end-side end E of the first electrode 410 by a first extended portion EP1, and the second separator 430b extends further than the winding-end-side end E of the first electrode 410 by a third extended portion EP3.

In FIG. 5, the first extended portion EP1, the third extended portion EP3, and the second extended portion EP2 are shown in order of size, but this is only an example. That is, the relative sizes between the first extended portion EP1, the second extended portion EP2, and the third extended portion EP3 may be different from those shown in FIG. 5. In addition, the sizes of the first extended portion EP1, the second extended portion EP2, and the third extended portion EP3 may also vary depending on the design or structure of the electrode assembly. For example, the first extended portion EP1, the second extended portion EP2, and the third extended portion EP3 may each be approximately 5 to 15 mm.

FIG. 6 illustrates a configuration of a cylindrical electrode assembly according to one embodiment. In FIG. 6, the winding-end portion is shown in a state before winding, and the remaining portion excluding the winding-end portion is shown in a state in which it is wound in the shape of a jelly roll J/R. This is to help understand the technical idea of this embodiment more clearly. It is obvious to those skilled in the art that the completed cylindrical electrode assembly, as shown in FIG. 4, also has the winding-end portion wound. The winding-end portion of the electrode assembly illustrated in FIG. 6 may correspond to the winding-end portion of the laminate illustrated in FIG. 5.

Referring to FIG. 6, the electrode assembly 400 has a structure in which the first extended portion EP1 of the first separator 430a in the winding-end portion is bent to surround the winding-end-side end E of the first electrode 410. That is, the winding-end-side end E of the first electrode 410 is surrounded by the first extended portion EP1 and is not exposed to the outside. To this end, the first extended portion EP1 may first be bent in a direction of the first electrode 410 and may also have a form bent in a direction of the jelly roll J/R.

Accordingly, in a structure in which the first extended portion EP1 of the first separator 430a is bent to surround the winding-end-side end E of the first electrode 410, the stress concentrated on the second electrode 420 due to the change caused by the winding-end-side end E of the first electrode 410 may be relieved. More specifically, the winding-end-side end E of the first electrode 410, particularly a corner portion of the winding-end-side end E, is also surrounded with the first extended portion EP1 of the first separator 430a. The first extended portion EP1 of the corner portion may be interposed between the winding-end-side end E of the first electrode 410 and the second electrode 420 facing each other to buffer the step. As a result, the stress applied to the second electrode 420 facing the winding-end-side end E of the first electrode 410 may be relieved, thereby suppressing the occurrence of cracks in the second electrode 420.

According to one embodiment, in order to enhance a stress relief effect by the corner portion, the first extended portion EP1 of the first separator 430a may be bent around the corner portion of the winding-end-side end E of the first electrode 410 to surround the corner portion. The corner portion of the winding-end-side end E of the first electrode 410 may be the corner portion adjacent to the second electrode 420. The corner portion of the winding-end-side end E of the first electrode 410 may also be surrounded by the first extended portion EP1 having a bent profile. As a result of the bent profile, the stress applied to the second electrode 420 facing the winding-end-side end E of the first electrode 410 may be more relieved.

Additionally, the first extended portion EP1 of the first separator 430a may be between 5 and 15 mm long. In this case, the first extended portion EP1 of the first separator 430a may completely come into contact with and surround an end portion including the winding-end-side end E of the first electrode 410. In an alternative case, only a part of the first extended portion EP1 of the first separator 430a may come into contact with and surround the end portion including the winding-end-side end E of the first electrode 410, and the remaining part may be folded so that the first separator 430a overlaps itself. In the latter case, the overlapping portion of the first separator 430a also serves to alleviate the step, and thus, the stress applied to the second electrode 420 may be further relieved.

In order to easily surround the winding-end-side end E of the first electrode 410 with the first extended portion EP1 of the first separator 430a, the first separator 430a may have a structure including a coating layer formed on one surface or both surfaces of the porous substrate. Accordingly, the first extended portion EP1 of the first separator 430a may be bent to surround the winding-end-side end E of the first electrode 410 using electrostatic attraction.

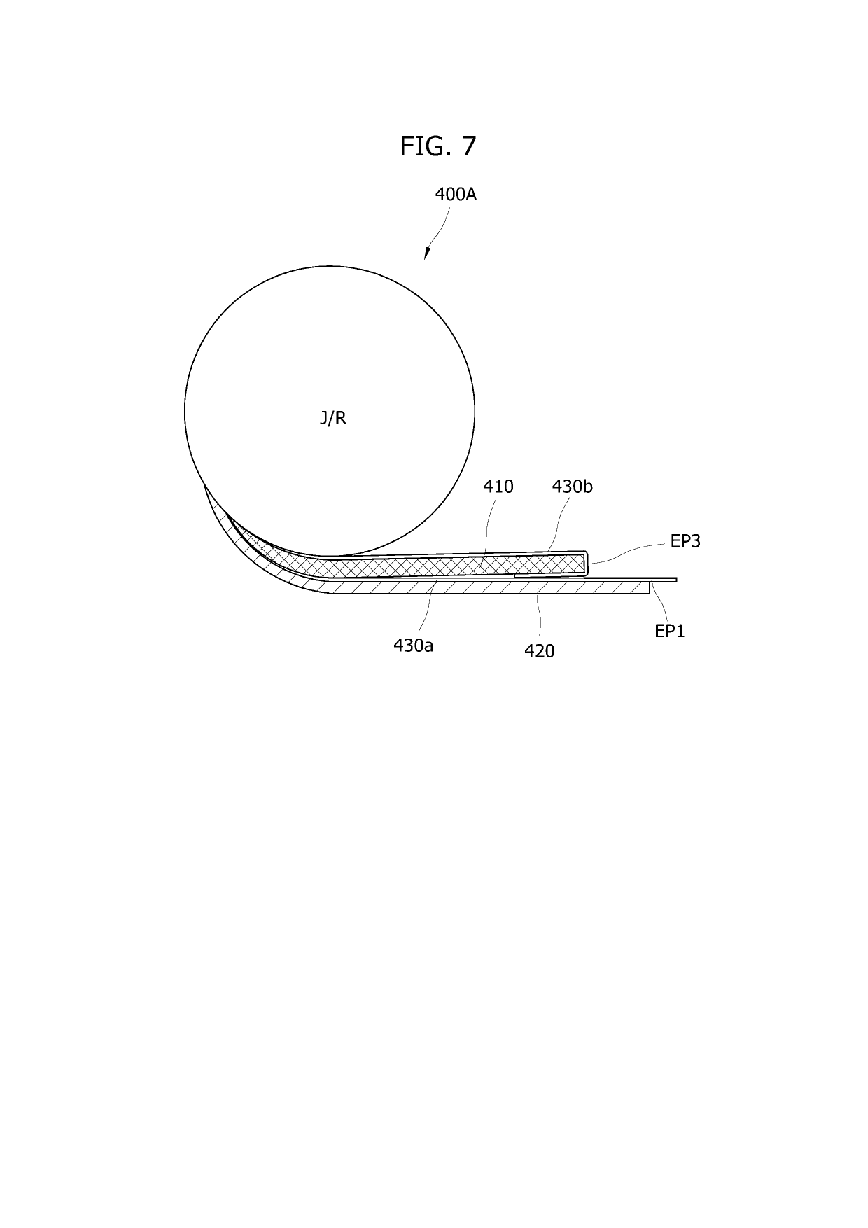

FIG. 7 illustrates a configuration of a cylindrical electrode assembly according to another embodiment. In FIG. 7, the winding-end portion is shown in a state before winding, and the remaining portion excluding the winding-end portion is shown in a state in which it is wound in the shape of the jelly roll J/R, which is intended to more clearly illustrate the technical idea of the present embodiment. It is obvious to those skilled in the art that the completed cylindrical electrode assembly, as shown in FIG. 4, also has the winding-end portion wound. The winding-end portion of the electrode assembly illustrated in FIG. 7 may correspond to the winding-end portion of the laminate illustrated in FIG. 5.

Referring to FIG. 7, an electrode assembly 400A has a structure in which the third extended portion EP3 of the second separator 430b in the winding-end portion is bent to surround the winding-end-side end E of the first electrode 410. That is, the winding-end-side end E of the first electrode 410 is surrounded by the third extended portion EP3 and is not exposed to the outside. To this end, the third extended portion EP3 may first be bent in the direction of the first electrode 410 and may also have a form bent in the direction of the jelly roll J/R.

In a structure in which the third extended portion EP3 of the second separator 430b is bent to surround the winding-end-side end E of the first electrode 410, the stress concentrated on the second electrode 420 due to the change caused by the winding-end-side end E of the first electrode 410 may be relieved. More specifically, the winding-end-side end E of the first electrode 410, particularly the corner portion of the winding-end-side end E, is also surrounded with the third extended portion EP3 of the second separator 430b. The third extended portion EP3 of the corner portion may be interposed between the winding-end-side end E of the first electrode 410 and the second electrode 420 facing each other to buffer the step. Therefore, the stress applied to the second electrode 420 facing the winding-end-side end E of the first electrode 410 may be relieved, thereby suppressing the occurrence of cracks in the second electrode 420.

According to one embodiment, in order to enhance a stress relief effect by the corner portion, the third extended portion EP3 of the second separator 430b may be bent to surround the corner portion of the winding-end-side end E of the first electrode 410. The corner portion of the winding-end-side end E of the first electrode 410 may be the corner portion adjacent to the second electrode 420. The corner portion of the winding-end-side end E of the first electrode 410 may also be surrounded by the third extended portion EP3 having a bent profile. As a result of the bent profile, the stress applied to the second electrode 420 facing the winding-end-side end E of the first electrode 410 may be more relieved.

Additionally, the third extended portion EP3 of the second separator 430b may be about 5 15 mm long. In this case, the third extended portion EP3 of the second separator 430b may completely come into contact with and surround the end portion including the winding-end-side end E of the first electrode 410. In an alternative case, only a part of the third extended portion EP3 of the second separator 430b may come into contact with and surround the end portion including the winding-end-side end E of the first electrode 410, and the remaining part may be folded so that the set of second separators 430b overlaps itself. In the latter case, the overlapping portion of the second separator 430b also serves to alleviate the step, and thus, the stress applied to the second electrode 420 may be further relieved.

In order to easily surround the winding-end-side end E of the first electrode 410 with the third extended portion EP3 of the second separator 430b, the second separator 430b may have a structure including a coating layer formed on one surface or both surfaces of the porous substrate. Accordingly, the third extended portion EP3 of the second separator 430b may be bent to surround the winding-end-side end E of the first electrode 410 using electrostatic attraction.

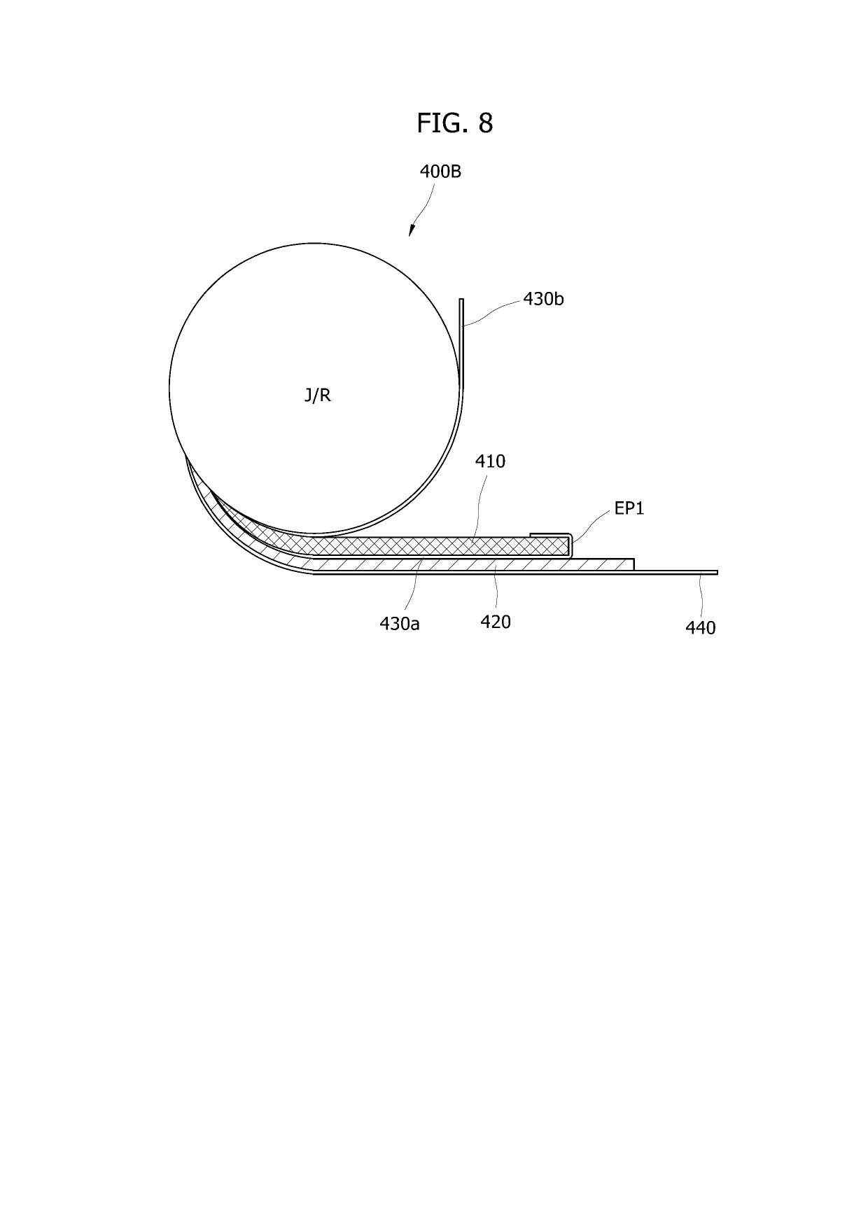

FIG. 8 illustrates a configuration of a cylindrical electrode assembly according to still another embodiment. In FIG. 8, the winding-end portion is shown in a state before winding, and the remaining portion excluding the winding-end portion is shown in a state in which it is wound in the shape of the jelly roll J/R, which is intended to more clearly illustrate the technical idea of the present embodiment. It is obvious to those skilled in the art that the completed cylindrical electrode assembly, as shown in FIG. 4, also has the winding portion in a wound.

Referring to FIG. 8, an electrode assembly 400B differs from the configuration of the winding-end portion of the electrode assembly 400 illustrated in FIG. 6 in that the electrode assembly 400B further includes a fixing tape 440 arranged on an outer surface of the second electrode 420 in the winding-end portion. The fixing tape 440 performs the function of fixing the second electrode 420 (which faces the winding-end-side end E of the first electrode 410) to the jelly roll J/R of the electrode assembly. To this end, the fixing tape 440 may be long enough to be attached to the jelly roll J/R, while covering at least a portion facing the winding-end-side end E of the first electrode 410. By additionally attaching the fixing tape 440 to fix the second electrode 420 to the jelly roll J/R, the stress concentrated on the part of the second electrode 420 facing the winding-end-side end E of the first electrode 410 may be further alleviated. The fixing tape 440 may be formed of an electrically insulating polymer material, such as polyimide, but is not limited thereto.

According to an embodiment of the present disclosure, cracks can be suppressed or prevented from occurring in a second electrode, e.g., a negative electrode, at a position facing an end portion of a first electrode, e.g., a positive electrode, in a winding-end portion of a cylindrical electrode assembly. However, the effects obtainable through the present disclosure are not limited to the effects described above, and other technical effects not mentioned will be clearly understood by those skilled in the art from the description of the disclosure.

Although the present disclosure has been described with reference to embodiments shown in the drawings, these embodiments are merely exemplary, and it should be understood by those skill in the art that various modifications and equivalents are possible.

What is claimed is:

1. An electrode assembly comprising:
a first electrode, a first separator, a second electrode, and a second separator, with the first electrode, the first separator, the second electrode, and the second separator being stacked and wound into a cylindrical electrode assembly,
wherein the first separator includes an extended portion that extends longer than a winding-end-side end of the first electrode, and
wherein the extended portion is bent to surround the winding-end-side end of the first electrode.

2. The electrode assembly of claim 1, wherein the extended portion is bent around a corner of the winding-end-side end of the first electrode to surround the corner.

3. The electrode assembly of claim 1, wherein the extended portion has a length of 5 to 15 mm, and at least a portion of the first extended portion is bent to surround the winding-end-side end of the first electrode.

4. The electrode assembly of claim 1, wherein the extended portion is a first extended portion, and
wherein the second electrode includes a second extended portion that extends longer than the winding-end-side end of the first electrode.

5. The electrode assembly of claim 1, wherein each of the first and second separators includes one or more coating layers formed on one or both surfaces of a porous substrate.

6. The electrode assembly of claim 1, wherein the first electrode is a positive electrode and the second electrode is a negative electrode.

7. The electrode assembly of claim 1, further comprising a fixing tape that covers a portion of the second electrode facing the winding-end side end of the first electrode, the fixing tape fixing the second electrode to the electrode assembly.

8. An electrode assembly comprising:
a first electrode, a first separator, a second electrode, and a second separator, with the first electrode, first separator, second electrode, second separator, being stacked and wound into a cylindrical electrode assembly,
wherein the second separator includes an extended portion that extends longer than a winding-end-side end of the first electrode, and
wherein the extended portion is bent to surround the winding-end-side end of the first electrode.

9. The electrode assembly of claim 8, wherein the extended portion is bent around a corner of the winding-end-side end of the first electrode to surround the corner.

10. The electrode assembly of claim 8, wherein the third extended portion has a length of 5 to 15 mm, and at least a portion of the third extended portion is bent to surround the winding-end-side end of the first electrode.

11. The electrode assembly of claim 8, wherein the extended portion is a first extended portion, and
wherein the second electrode includes a second extended portion that extends longer than the winding-end-side end of the first electrode.

12. The electrode assembly of claim 8, wherein each of the first and second separators includes one or more coating layers formed on one surface or both surfaces of a porous substrate.

13. The electrode assembly of claim 8, wherein the first electrode is a positive electrode and the second electrode is a negative electrode.

14. A battery comprising:
a cylindrical case; and
a cylindrical electrode assembly accommodated inside the case,
wherein the electrode assembly includes a first electrode, a first separator, a second electrode, and a second separator, with the first electrode, the first separator, the second electrode, and the second separator being stacked and wound,
wherein the first separator includes an extended portion that extends longer than a winding-end-side end of the first electrode, and
wherein the first extended portion is bent to surround the winding-end-side end of the first electrode.

15. The battery of claim 14, wherein the first extended portion is bent around a corner of the winding-end-side end of the first electrode to surround the corner.

16. The battery of claim 14, wherein the first extended portion has a length of 5 to 15 mm, and at least a portion of the first extended portion is bent to surround the winding-end-side end of the first electrode.

17. The battery of claim 14, wherein the extended portion is a first extended portion, and
wherein the second electrode includes a second extended portion that extends longer than the winding-end-side end of the first electrode.

18. The battery of claim 14, wherein each of the first and second separators includes one or more coating layers formed on one surface or both surfaces of a porous substrate.

19. The battery of claim 14, wherein the first electrode is a positive electrode and the second electrode is a negative electrode.

20. The battery of claim 14, further comprising a fixing tape that covers a portion of the second electrode facing the winding-end side end of the first electrode, the fixing tape fixing the second electrode to the electrode assembly.
